(19) United States
(12) Patent Application Publication
(10) Pub. No.: US 2010/0151747 A1
(43) Pub. Date: Jun. 17, 2010

(54) SPRING SHEET ASSEMBLY

(75) Inventor: FA-NING LU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/417,628

(22) Filed: Apr. 2, 2009

(30) Foreign Application Priority Data
Dec. 12, 2008 (CN) 200820303362.8

(51) Int. Cl. H01R 4/48

(52) U.S. Cl. 439/816

(57) ABSTRACT

A spring sheet assembly for electrically connecting a printed circuit board to ground includes a base and a conductive spring sheet. The conductive spring sheet includes a fixing portion and a resisting portion. The base defines a latching slot for detachably receiving the fixing portion of the spring sheet.

### BACKGROUND

1. Technical Field

The present disclosure relates to spring sheet assemblies.

2. Description of Related Art

Conventional methods for preventing electromagnetic interference (EMI) from leaking from digital electronic products generally use a spring sheet for electrically conducting EMI sources to the ground to eliminate the EMI. The spring sheet is fixed on the PCB of the electronic product by surface mounting technology (SMT). However, because different electronic products have various sizes, it is impossible for the SMT machine to suck all various spring sheets having high heights and/or complex shapes. In addition, it is also difficult to disassemble the spring sheet from the PCB while reworking the PCB, which wastes time and weakens the stability of the PCB.

Therefore, there is room for improvement within the art.

### BRIEF DESCRIPTION OF THE DRAWINGS

FIG. 1 is an exploded, isometric perspective view of a spring sheet assembly in accordance with an exemplary embodiment of the disclosure, the spring sheet assembly comprising a spring sheet and a base.

FIG. 2 is an assembled view of the spring sheet assembly of FIG. 1.

FIG. 3 is an isometric perspective view of the base of FIG. 1.

FIG. 4 is an isometric perspective view of a base in accordance with another exemplary embodiment of the disclosure.

FIG. 5 is an assembled view of the spring sheet assembly of FIG. 1 assembled between a PCB and a metal cage.

### DETAILED DESCRIPTION OF EMBODIMENTS

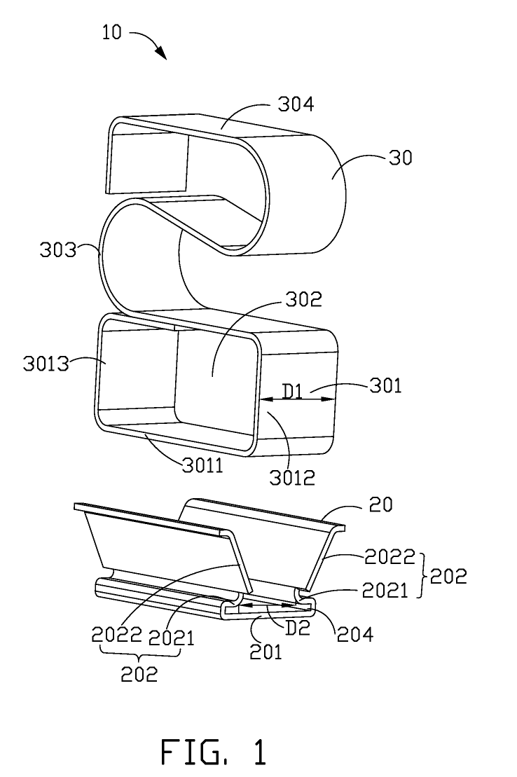

Referring to FIG. 1, a spring sheet assembly 10 according to an exemplary embodiment of the present disclosure comprises a base 20 and a conductive spring sheet 30 selected from a plurality of conductive spring sheets 30 having different heights (only one conductive spring sheet 30 is illustrated in FIG. 1 for simplicity). Each of selected one of the conductive spring sheets 30 is adaptable to be assembled to the base 20 and comprises a fixing portion 301 and a resisting portion 304. The resisting portions 304 of different conductive spring sheets 30 have different heights when not subjected to an external force. The fixing portion 301 comprises a bottom 3011 and at least one side wall extending from at least one end of the bottom 3011. In this exemplary embodiment, there are two opposite side walls 3012, 3013 respectively extending from two opposite ends of the bottom 3011, and which collectively define a surrounding space 302. In this exemplary embodiment, the spring sheet 30 further comprises an elastic portion 303 connected between the fixing portion 301 and the resisting portion 304, and forming substantially an “S” shape with the resisting portion 304. In other embodiments, the elastic portion 303 can form substantially a “Z” shape.

The base 20 comprises a base bottom 201 and a pair of bent portions 202 located at opposite edges of the base bottom 201, wherein the pair of bent portions 202 and the base bottom 201 collectively define a latching slot 204. Each bent portion 202 comprises a latching portion 2021 and a wing portion 2022. The two latching portions 2021 of the pair of bent portions 202 respectively extend from the opposite edges of the base bottom 201 and towards to each other, thus form the latching slot 204. The wing portions 2022 of the pair of bent portions 202 further extend from the latching portions 2021 respectively and form substantially a “V” shape for conveniently receiving the fixing portion 301 into the latching slot 204 and releasing the fixing portion 301 when applying an external force on the wing portions 2022.

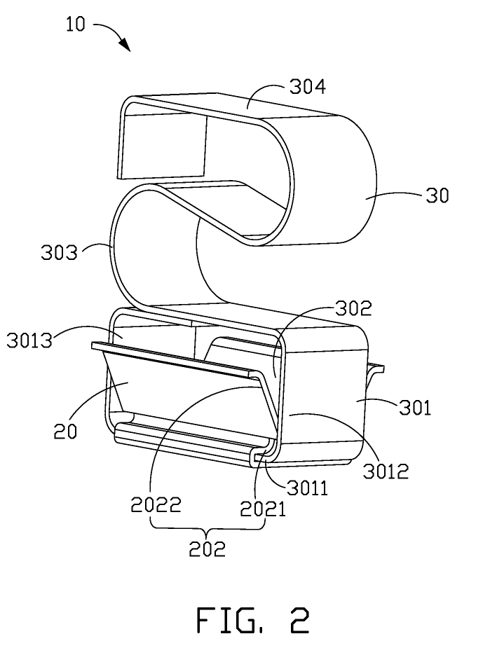

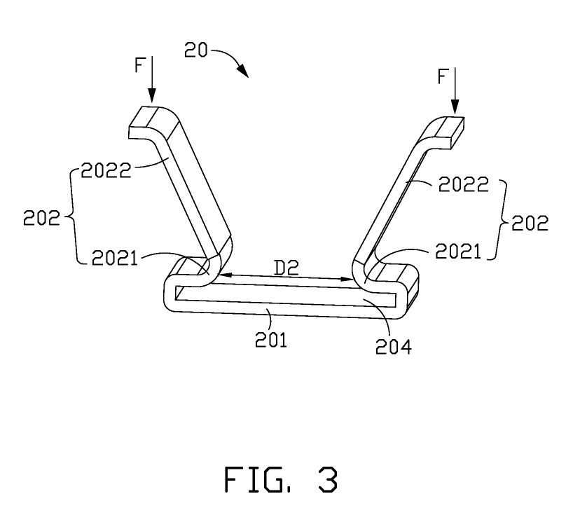

FIG. 2 shows an assembled view of the spring sheet assembly 10 of FIG. 1. When installing the spring sheet 30 into the base 20, the fixing portion 301 can be pushed into the latching slot 204 under an external force along the “V” shape formed by the wing portions 2022. Advantageously, another external force F can be put upon the two wing portions 2022, as illustrated in FIG. 3, thus the bent portions 202 move away from each other and provide a larger distance D2 than when there is no external force F. As a result, the bottom 3011 of the fixing portion 301 can be easily fixed into the latching slot 204 of the base 20. After removal of the external force F, the spring sheet 30 is firmly fixed to the base 20. To release the spring sheet 30 from the base 20, an external force F is applied to the two wing portions 2022, causing the bent portions 202 to move away from each other and provide a larger distance D2 than when there is no external force F. The fixing portion 301 is then taken out from the latching slot 204 and the spring sheet 30 disassembled from the base 20.

Referring to FIG. 3, an isometric perspective view of the base 20 of FIG. 1 is shown. The base bottom 201 is flat, and the base 20 is mounted on the PCB by surface mounting technology (SMT) process. It is easy for a SMT machine to suck the base 20 because of its low height and simple shape, and the base 20 also has good performance of sucking tin thereon.

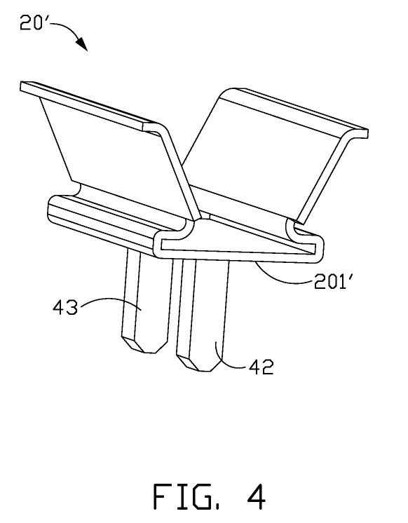

Referring FIG. 4, it shows an isometric perspective view of a base 20′ in accordance with another exemplary embodiment of the present disclosure. The difference between the base 20′ and the base 20 of FIG. 3 is in that the base 20′ comprises at least one pin extending vertically from the base bottom 201′ and inserted into at least one via defined in the PCB to reliably connect the base 20′ to the PCB. In this exemplary embodiment, the base 20′ comprises two pins 42, 43 inserted in two vias defined in the PCB to connect the base 20′ to the PCB reliably.

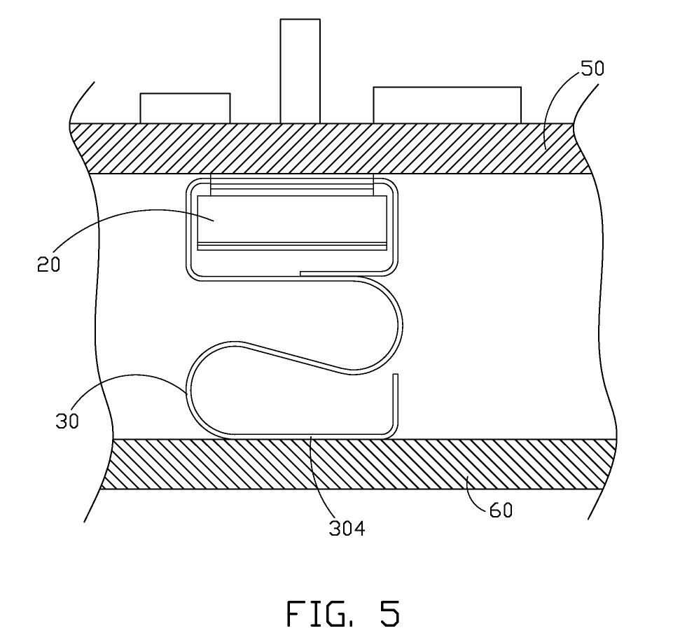

Referring FIG. 2 and FIG. 5 simultaneously, FIG. 5 shows an assembled view of the spring sheet assembly 10 of FIG. 1 assembled between a PCB 50 and a metal cage 60. The spring sheet assembly 10 is located between the PCB 50 and an inner surface of the metal cage 60 to electrically connecting the PCB 50 to the metal cage 60 to reliably ground the PCB 50. The base 20 is mounted on the PCB 50 by SMT process, the fixing portion 301 of the spring sheet 30 is latched into the latching slot 204, and the resisting portion 304 of the spring sheet 30 abuts against the inner surface of the metal cage 60 under the elasticity of the elastic portion 303 of the spring sheet 30, which form a reliable ground path. When replacing the current spring sheet 30 with a different spring sheet having a different height, the bent portions 202 are pushed under the external force to release the current spring sheet 30 from the base 20, and another spring sheet is assembled to the base 20, by the method as description above. The whole process of changing the spring sheet 30 is convenient and efficient.

Compared with conventional spring sheets, the spring sheet assembly of this disclosure has the following advantages. Firstly, in the SMT process, it is easy for the SMT machine to suck the base 20 of the spring sheet assembly 10 and the base 20 has a good performance of absorbing tin due to low height and simple shape thereof. Secondly, it is convenient to replace the current spring sheet with another spring sheet having different height from that of the current spring sheet without changing the design of the PCB and the metal cage, because the spring sheet can be easily disassembled from the PCB by pressing the wing portions of the base 20. As a result, the productivity and the stability of the PCB are improved.

While exemplary embodiments have been described, it should be understood that they have been presented by way of example only and not by way of limitation. The breadth and scope of the disclosure should not be limited by the described exemplary embodiments, but only in accordance with the following claims and their equivalents.

What is claimed is:

1. A spring sheet assembly for electrically connecting a printed circuit board (PCB) to ground, the spring sheet assembly comprising:
a conductive spring sheet comprising a fixing portion and a resisting portion; and
a base defining a latching slot for detachably receiving the fixing portion of the selected conductive spring sheet.

2. The spring sheet assembly as claimed in claim 1, wherein the base comprises a base bottom and a pair of bent portions located at opposite edges of the base bottom, wherein the pair of bent portions and the base bottom collectively define the latching slot.

3. The spring sheet assembly as claimed in claim 2, wherein each bent portion comprises a latching portion, and the latching portions of the pair bent portions respectively extend from the opposite edges of the base bottom and toward to each other, forming the latching slot.

4. The spring sheet assembly as claimed in claim 3, wherein each bent portion comprises a wing portion, and the wing portions extend from their respective latching portions.

5. The spring sheet assembly as claimed in claim 4, wherein the wing portions are substantially “V”-shaped.

6. The spring sheet assembly as claimed in claim 1, wherein the fixing portion of the conductive spring sheet comprises a bottom and at least one side wall extending from at least one end of the bottom.

7. The spring sheet assembly as claimed in claim 6, wherein the bottom of the fixing portion is latched into the latching slot, and the at least one side wall is located beside the bent portions of the base.

8. The spring sheet assembly as claimed in claim 1, wherein the fixing portion of the conductive spring sheet comprises two side walls respectively extending from two opposite ends of the bottom, and which collectively define a surrounding space.

9. The spring sheet assembly as claimed in claim 1, wherein the conductive spring sheet further comprises an elastic portion connected between the fixing portion and the resisting portion.

10. The spring sheet assembly as claimed in claim 9, wherein the resisting portion and the elastic portion collectively form substantially an “S” shape or a “Z” shape.

11. The spring sheet assembly as claimed in claim 1, wherein the base is electrically connected to the PCB by surface mounting technology(SMT) process.

12. The spring sheet assembly as claimed in claim 1, wherein the base comprises at least one pin inserted into at least one via defined in the PCB to connect the base to the PCB.

13. The spring sheet assembly as claimed in claim 1, wherein the conductive spring sheet is selected from a plurality of conductive spring sheets having different heights when not subjected to an external force.
